(19) United States
(12) Patent Application Publication
(10) Pub. No.: US 2024/0150547 A1
(43) Pub. Date: May 9, 2024

(54) COMPOSITE MATERIAL SUBSTRATE AND FABRICATION METHOD THEREOF

(71) Applicant: NAN YA PLASTICS CORPORATION, Taipei (TW)

(72) Inventors: Te-Chao Liao, TAIPEI (TW); Hung-Yi Chang, TAIPEI (TW); Chia-Lin Liu, TAIPEI (TW); Wei-Ru Huang, TAIPEI (TW)

(73) Assignee: NAN YA PLASTICS CORPORATION, TAIPEI (TW)

(21) Appl. No.: 17/993,851

(22) Filed: Nov. 23, 2022

(30) Foreign Application Priority Data
Oct. 20, 2022 (TW) 111139768

(51) Int. Cl. C08K 3/36; B32B 15/08; B32B 15/20; C08G 59/24; C08G 61/12; C08G 73/10; C08J 5/18; C08J 5/24

(52) U.S. Cl. CPC C08K 3/36; B32B 15/08; B32B 15/20; C08G 59/245; C08G 61/122; C08G 73/10; C08J 5/18; C08J 5/244; B32B 2250/03; B32B 2307/204; B32B 2307/306; B32B 2311/12; B32B 2457/00; C08K 2201/003; C08K 2201/014

(57) ABSTRACT

A composite material substrate includes an inorganic filler, a resin composition, and a dispersant. The resin composition includes a bismaleimide resin, a naphthalene ring-containing epoxy resin, and a benzoxazine resin. The inorganic filler, the resin composition, and the dispersant are mixed together.

### CROSS-REFERENCE TO RELATED APPLICATION

This application claims the priority benefit of Taiwan application serial no. 111139768, filed on Oct. 20, 2022. The entirety of the above-mentioned patent application is hereby incorporated by reference herein and made a part of this specification.

### BACKGROUND

### Technical Field

The disclosure relates to a composite material substrate, and in particular, to a composite material substrate comprising an inorganic filler and a resin composition and a fabrication method thereof.

### Description of Related Art

Because of its cross-linked structure and the high heat resistance or dimensional stability, the composition of thermosetting resin is widely used in electronic equipment and other fields. In recent years, with the development of the 5G communication, the demand for high-frequency transmission, high-speed signal transmission, and low latency is on the rise in the industry. Therefore, at present, the related fields are devoted to the research and development of substrate materials with a high glass transition temperature (Tg), a low dielectric constant (Dₖ), a low dissipation factor (D_{f}), and good heat resistance to meet the requirements of dielectric properties (the low dielectric constant and the low dissipation factor) and heat resistance in an electronic substrate.

### SUMMARY

The disclosure provides a composite material substrate, which has the advantages of a low coefficient of thermal expansion (CTE) and a high rigidity modulus.

At least one embodiment of the disclosure provides a composite material substrate. The composite material substrate includes an inorganic filler, a resin composition, and a dispersant. The inorganic filler includes a first spherical inorganic particle and a filler material. The average particle diameter of the first spherical inorganic particle is 300 nm to 600 nm. The filler material includes at least one of a second spherical inorganic particle and a flaky inorganic particle. The average particle diameter of the second spherical inorganic particle is 20 nm to 50 nm, and the average thickness of the flaky inorganic particle is 0.5 um to 2 um. The resin composition includes a bismaleimide resin, a naphthalene ring-containing epoxy resin, and a benzoxazine resin. The inorganic filler, the resin composition, and the dispersant are mixed together.

At least one embodiment of the disclosure provides a fabrication method of a composite material substrate including mixing an inorganic filler, a dispersant, and a solvent to form a dispersion liquid; dissolving a resin composition into the dispersion liquid to form a slurry, in which the resin composition includes a bismaleimide resin, a naphthalene ring-containing epoxy resin, and a benzoxazine resin; and hardening the slurry.

Based on the above, since the packing density of the inorganic filler in the composite material substrate is 60% to 80%, the CTE of the composite material substrate may be reduced, and the rigidity modulus of the composite material substrate may be increased.

### BRIEF DESCRIPTION OF THE DRAWING

FIG. 1 is a schematic cross-sectional diagram of a composite material substrate according to an embodiment of the disclosure.

FIG. 2 is a schematic cross-sectional diagram of a composite material substrate according to an embodiment of the disclosure.

FIG. 3 is a flow diagram of a fabrication method of a composite material substrate according to an embodiment of the disclosure.

### DESCRIPTION OF THE EMBODIMENTS

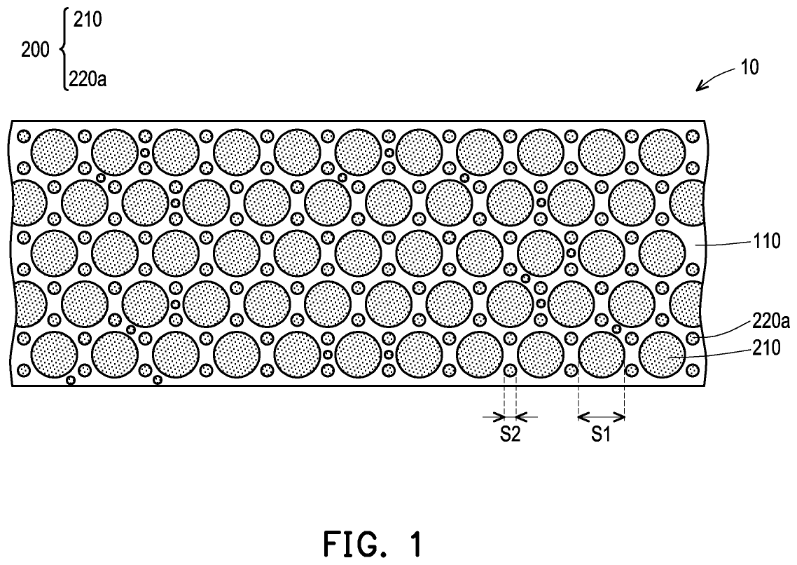

FIG. 1 is a schematic cross-sectional diagram of a composite material substrate 10 according to an embodiment of the disclosure. Referring to FIG. 1, the composite material substrate 10 includes a resin composition 110, an inorganic filler 200, and a dispersant (not shown). In some embodiments, the composite material substrate 10 also includes a hardener (not shown), a siloxane coupling agent (not shown), and a catalyst (not shown). The resin composition 110, the inorganic filler 200, the dispersant, the hardener, the siloxane coupling agent, and the catalyst are mixed together.

The resin composition 110 includes a bismaleimide resin, a naphthalene ring-containing epoxy resin, and a benzoxazine resin. In the resin composition 110, the bismaleimide resin is 10 wt % to 70 wt %, the naphthalene ring-containing epoxy resin is 10 wt % to 50 wt %, and the benzoxazine resin is 10 wt % to 50 wt %.

In some embodiments, the bismaleimide resin is, for example, a 4,4′-diphenylmethane bismaleimide, an oligomer of phenylmethane maleimide, an m-phenylene bismaleimide, a bisphenol A diphenyl ether bismaleimide, a 3,3′-dimethyl-5,5′-diethyl-4,4′-diphenylmethane bismaleimide, a 4-methyl-1,3-phenylene bismaleimide, and a 1,6-bismaleimide-(2,2,4-trimethyl)hexane. However, the disclosure is not limited hereto.

In some embodiments, the naphthalene ring-containing epoxy resin includes a naphthalene ring structure. The naphthalene ring structure may improve the heat resistance of the naphthalene ring-containing epoxy resin because of its small bond rotation ability. In addition, the epoxy group in the naphthalene ring-containing epoxy resin has a high cross-linking density after curing. Therefore, the naphthalene ring-containing epoxy resin combining the naphthalene ring structure and the epoxy group has the advantages of a high rigidity modulus and a high heat resistance, and may reduce the CTE of the resin composition. In some embodiments, the naphthalene ring-containing epoxy resin includes a monomeric multifunctional naphthalene ring epoxy resin (as shown in Structural Formula 1), a novolac-type naphthalene-based epoxy resin (as shown in Structural Formula 2), and/or other naphthalene ring-containing epoxy resins. In Structural Formula 2, n is, for example, 1 to 7.

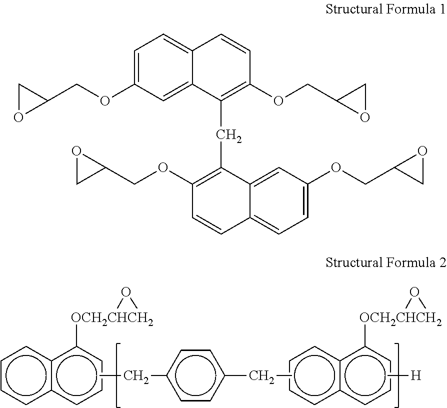

In some embodiments, the benzoxazine resin is prepared by a condensation polymerization reaction using a phenolic compound, a formaldehyde, and a primary amine compound as reactants. In some embodiments, the benzoxazine resin has the advantage of accelerating the rate of the cross-linking reaction of the resin composition 110. In some embodiments, the benzoxazine resin includes, for example, a Bisphenol A benzoxazine (as shown in Structural Formula 3), a bisphenol F benzoxazine (as shown in Structural Formula 4), phenolphthalein benzoxazine (as shown in Structural Formula 5), a thiodiphenol benzoxazine (as shown in Structural Formula 6), or other suitable benzoxazine resins.

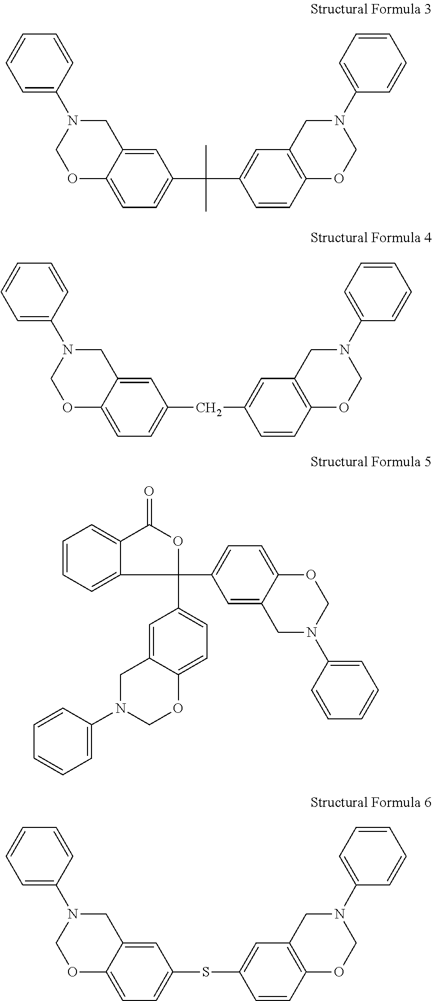 [SMILES: CC(C)(c1ccc2c(c1)CN(c1ccccc1)CO2)c1ccc2c(c1)CN(c1ccccc1)CO2 ; c1ccc(N2COc3ccc(Cc4ccc5c(c4)CN(c4ccccc4)CO5)cc3C2)cc1 ; O=C1OC(c2ccc3c(c2)CN(c2ccccc2)CO3)(c2ccc3c(c2)CN(c2ccccc2)CO3)c2ccccc21 ; c1ccc(N2COc3ccc(Sc4ccc5c(c4)CN(c4ccccc4)CO5)cc3C2)cc1]

The inorganic filler 200 is the main component of the composite material substrate 10. In the embodiment, the inorganic filler 200 is mainly composed of a first spherical inorganic particle 210, and a small amount of a filler material is used to increase the packing density of the inorganic substance. In the embodiment, the aforementioned filler material is a second spherical inorganic particle 220a, and the first spherical inorganic particle 210 and the second spherical inorganic particle 220a include different particle sizes. In other embodiments, the filler material may include a flaky or one-dimensional structured inorganic filler. In some embodiments, the weight of the inorganic filler 200 is, for example, 100 parts by weight to 300 parts by weight, compared to a total of 100 parts by weight of the resin composition 110. For example, 100 parts by weight, 150 parts by weight, 200 parts by weight, 250 parts by weight, or 300 parts by weight.

In some embodiments, the material of the first spherical inorganic particle 210 includes a silicon oxide or other suitable materials. In some embodiments, an average particle diameter S1 of the first spherical inorganic particle 210 is 300 nm to 600 nm. In some embodiments, the first spherical inorganic particle 210 have a narrower particle diameter range, that is, a smaller maximum allowable particle diameter, thereby allowing the first spherical inorganic particle 210 to be more neatly packed. For example, the maximum allowable particle diameter of the first spherical inorganic particle 210 is less than or equal to 5 um, and the difference between D10 and D90 of the first spherical inorganic particle 210 is less than 500 nm. In some embodiments, by mixing the inorganic filler with different particle diameters and shapes, the composite material substrate 10 has the advantages of a low CTE and a high rigidity modulus.

In some embodiments, the materials of the first spherical inorganic particle 210 and the second spherical inorganic particle 220a include a silicon oxide or other suitable materials. In some embodiments, an average particle diameter S2 of the second spherical inorganic particle 220a is 20 nm to 50 nm. In some embodiments, the first spherical inorganic particle 210 and the second spherical inorganic particle 220a each have a narrower particle diameter range, thereby allowing the first spherical inorganic particle 210 and the second spherical inorganic particle 220a to have a tighter packing effect as a whole. For example, the difference between D10 and D90 of the second spherical inorganic particle 220a is less than 20 nm. In some embodiments, the ratio of the average particle diameter S1 of the first spherical inorganic particle 210 to the average particle diameter S2 of the second spherical inorganic particle 220a is 3 to 20. Therefore, the second spherical inorganic particle 220a may be preferably filled between the first spherical inorganic particle 210. In some embodiments, the weight of the resin composition is 100 parts by weight, the first spherical inorganic particle 210 is 100 to 300 parts by weight, and the second spherical inorganic particle 220a is 20 to 50 parts by weight. In some embodiments, the composite material substrate 10 has the advantages of a low CTE and a high rigidity modulus by increasing the tight packing degree of the inorganic filler 200.

The dispersant helps to distribute the inorganic filler more uniformly, thereby increasing the packing density of the inorganic filler. In some embodiments, the dispersant is, for example, an ionic dispersant, a polymeric dispersant, or other suitable dispersants. In some embodiments, the weight of the dispersant is greater than 0 parts by weight and less than or equal to 3 parts by weight, compared to a total of 100 parts by weight of the resin composition 110.

The hardener helps to harden the resin composition 110. In some embodiments, the weight of the hardener is greater than 0 parts by weight and less than or equal to 30 parts by weight, compared to a total of 100 parts by weight of the resin composition 110.

The siloxane coupling agent include, but are not limited to, a siloxane. In addition, according to the type of functional group, it may be divided into an amino silane compound, an epoxide silane compound, a vinyl silane compound, an ester silane compound, a hydroxy silane compound, an isocyanate silane compound, a methyl silane acryloyloxysilane compound, and an acryloxysilane compound. In some embodiments, the weight of the siloxane coupling agent is 0.1 to 4 parts by weight, compared to a total of 100 parts by weight of the resin composition 110.

The catalyst includes, for example, a catalyst and a peroxide. For example, the catalyst includes a 1-cyanoethyl-2-phenylimidazole (2PZCN; CAS: 23996-12-5), a 1-benzyl-2-phenylimidazole (1B2PZ; CAS: 37734-89-7), a Thiabendazole (TBZ; CAS: 7724-48-3), or a combination of the above, and the imidazole compound with the best lifting effect is, for example, the 1-benzyl-2-phenylimidazole, but the disclosure is not limited hereto, and other suitable catalysts may be chosen for the catalyst according to the actual design requirement. In some embodiments, compared to a total of 100 parts by weight of the resin composition 110, the weight of the catalyst is greater than 0 parts by weight and less than or equal to 10 parts by weight.

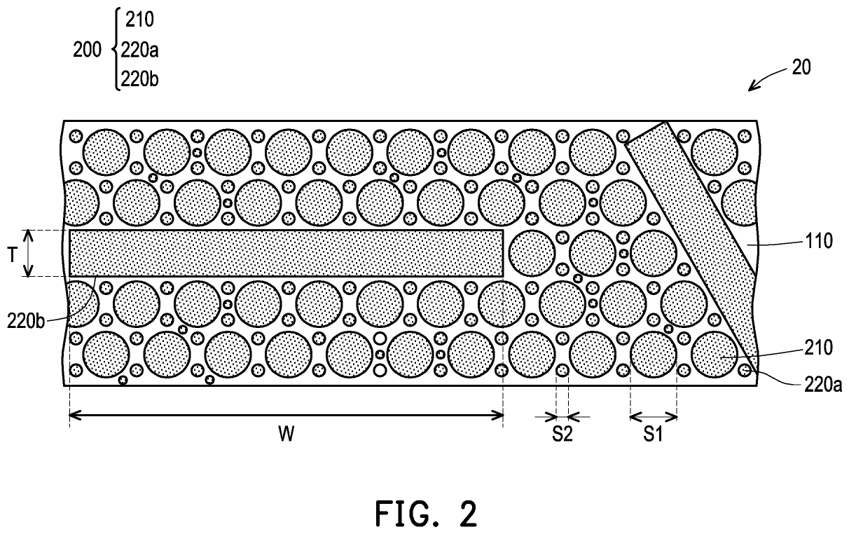

FIG. 2 is a schematic cross-sectional diagram of a composite material substrate 20 according to an embodiment of the disclosure. The composite material substrate 20 of FIG. 2 is similar to the composite material substrate 10 of FIG. 1, except that the filler material in the inorganic filler 200 of the composite material substrate 20 further includes multiple flaky inorganic particles 220b.

In some embodiments, the material of the flaky inorganic particle 220b includes a silicon oxide or other suitable materials. In some embodiments, an average thickness T of the flaky inorganic particle 220b is 0.5 um to 2 um. In some embodiments, an average diameter W of the flaky inorganic particle 210 is 5 um to 10 um. In some embodiments, the ratio of the average diameter W to the average thickness T of the flaky inorganic particle 220b is greater than or equal to 10. In the embodiment, by mixing the inorganic filler with different particle diameters and shapes, the packing density of the inorganic filler is increased, thereby allowing the composite material substrate 20 to have the advantages of a low CTE and a high rigidity modulus.

In the embodiment, the composite material substrate 20 further includes the resin composition 110, the dispersant (not shown), the hardener (not shown), the siloxane coupling agent (not shown), and the catalyst (not shown). For the description of the resin composition 110, the dispersant, the hardener, the siloxane coupling agent, and the catalyst, please refer to the embodiment of FIG. 1, and the details are not repeated here.

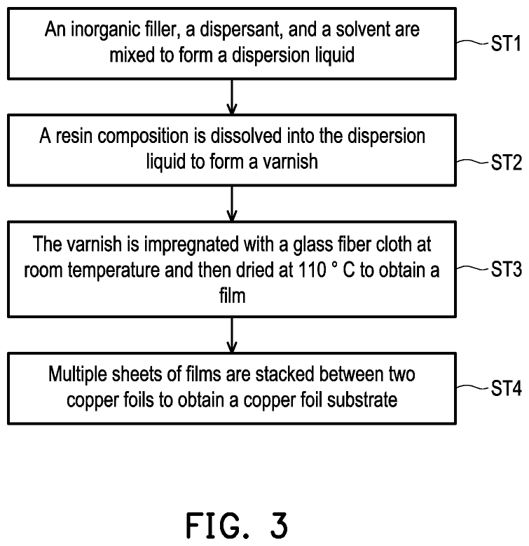

FIG. 3 is a flow diagram of a fabrication method of a composite material substrate (e.g., the composite material substrate in any of the foregoing embodiments) according to an embodiment of the disclosure.

Referring to FIG. 3, in step ST1, the inorganic filler, the dispersant, and the solvent are mixed to form a dispersion liquid. In some embodiments, the solvent includes, for example, water, an organic solvent, or a combination thereof. The inorganic filler is, for example, the flaky inorganic particle or the spherical inorganic particle, and the inorganic filler is uniformly dispersed in the dispersion liquid.

In step ST2, the resin composition is dissolved into the dispersion liquid to form a varnish, in which the resin composition includes the bismaleimide resin, the naphthalene ring-containing epoxy resin and the benzoxazine resin. In some embodiments, the solids content of the slurry is 40 wt % to 70 wt %. In some embodiments, the hardener, the siloxane coupling agent, and the catalyst are also added to the dispersion liquid.

In step ST3, the above varnish is impregnated with a glass fiber cloth (Nanya Plastics Co., Ltd., cloth type 1078) at room temperature in an impregnating machine, and then dried in the impregnating machine at 110° C. for several minutes to obtain a film (prepreg) with a resin content of 76 wt %.

Finally, in step ST4, multiple sheets (for example, 4 sheets) of films are stacked between two copper foils with a thickness of 35 um, kept at the constant temperature under the pressure of 25 kg/cm2 and the temperature of 85° C. for 20 minutes, kept at the constant temperature again for 120 minutes after heating to 185° C. at a heating rate of 3° C./min, and then slowly cooled to 130° C. to obtain 0.8 mm thick copper foil substrate (COPPER CLAD LAMINATES, CCL).

Table 1 provides the formulations of the composite material substrates of some examples and comparative examples. In Table 1, the content of each component is represented by weight percent.

TABLE 1

| inorganic filler | | | | | | | |
|---|---|---|---|---|---|---|---|
| (silicon dioxide) | | | | | | | |
| | | | spherical | | | | |
| | | | inorganic | | | | |
| | | spherical | particle | | | | |
| | | inorganic | dispersed in | | | | |
| | | particle in dry | dispersion | | | | |
| | | powder state | liquid | | | | |
| | | D50 = 0.5 um | D50 = 0.5 um | | | | |
| | | (SC2500-SQ, | (SC2050- | | | | |
| | | maximum | SQ, maximum | | | | |
| nano-spherical | | allowable | allowable | | siloxane | | |
| inorganic | flaky | particle | particle | | coupling | hardener | |
| particle | inorganic | diameter = | diameter = | catalyst | agent | | HP- |
| D50 = 35 nm | particle | 45 um) | 5 um) | TPP-MK | Z6030 | DDS | 2000 |
| 10 | 3.85 | | 55 | 0.05 | 0.5 | | |
| wt % | wt % | | wt % | wt % | wt % | | |
| 13.85 | | | 55 | 0.05 | 0.5 | | 1 |
| wt % | | | wt % | wt % | wt % | | wt % |
| 11.85 | 2 | | 55 | 0.05 | 0.5 | | |
| wt % | wt % | | wt % | wt % | wt % | | |
| 13.85 | | 55 | | 0.05 | 0.5 | 1 | |
| wt % | | wt % | | wt % | wt % | wt % | |
| | 13.85 | 55 | | 0.05 | 0.5 | | |
| | wt % | wt % | | wt % | wt % | | |
| 10 | 3.85 | 55 | | 0.05 | 0.5 | | |
| wt % | wt % | wt % | | wt % | wt % | | |
| | | | 68.85 | 0.05 | 0.5 | | |
| | | | wt % | wt % | wt % | | |

| | naphthalene ring-containing | | | benzoxazine | bismaleimide | |
|---|---|---|---|---|---|---|
| hardener | epoxy resin | | | resin | resin | |
| S-1817 | HP9500 | HP6000 | HP4710 | KB-610 | BMI-2300 | Material |
| 1 | | | 8.9 | 5.9 | 14.8 | Example 1 |
| wt % | | | wt % | wt % | wt % | |
| | | | 8.9 | 5.9 | 14.8 | Example 2 |
| | | | wt % | wt % | wt % | |
| 1 | | | 8.9 | 5.9 | 14.8 | Example 3 |
| wt % | | | wt % | wt % | wt % | |
| | | 8.9 | | 5.9 | 14.8 | Comparative |
| | | wt % | | wt % | wt % | Example 1 |
| 1 | 8.9 | | | 5.9 | 14.8 | Comparative |
| wt % | wt % | | | wt % | wt % | Example 2 |
| 1 | | | 8.9 | 5.9 | 14.8 | Comparative |
| wt % | | | wt % | wt % | wt % | Example 3 |
| 1 | | | 8.9 | 5.9 | 14.8 | Comparative |
| wt % | | | wt % | wt % | wt % | Example 4 |

In Table 1, the spherical inorganic particle dispersed in the dispersion liquid corresponds to the first spherical inorganic particle 210 in the embodiment of FIG. 1 or FIG. 2, and the maximum allowable particle size of the spherical inorganic particle dispersed in the dispersion liquid is smaller (5 um), and the difference between D10 and D90 is less than 500 nm. In Table 1, the maximum allowable particle size of the spherical inorganic particle in the state of dry powder is larger (45 μm), and the difference between D10 and D90 is greater than 800 nm. In Table 1, the flaky inorganic particle and the nano-spherical inorganic particle correspond to the flaky inorganic particle 220b and the second spherical inorganic particle 220a in the embodiment of FIG. 2, respectively.

In Example 1 and Example 3 of Table 1, the spherical inorganic particle, the flaky inorganic particle, and the nano-spherical inorganic particle were dispersed in the dispersion liquid, and then the resin composition was added to form the varnish. In Example 2 of Table 1, the spherical inorganic particle and the nano-spherical inorganic particle were dispersed in the dispersion liquid, and then the resin composition was added to form the varnish. In Comparative Example 1 of Table 1, the spherical inorganic particle and the nano-spherical inorganic particle were mixed in the state of dry powder, and then the resin composition was added to form the varnish. In Comparative Example 2 of Table 1, the spherical inorganic particle and the flaky inorganic particle were mixed in the state of dry powder, and then the resin composition was added to form the varnish. In Comparative Example 3 of Table 1, the spherical inorganic particle, the flaky inorganic particle, and the nano-spherical inorganic particle were mixed in the state of dry powder, and then the resin composition was added to form the varnish. In Comparative Example 4 of Table 1, the spherical inorganic particle dispersed in the dispersion liquid was directly added to the resin composition to form the varnish, and the nano-spherical inorganic particle and the flaky inorganic particle were not added to the dispersion liquid.

Comparing the packing densities of the inorganic fillers obtained in the various examples and comparative examples of Table 1, it may be known that the spherical inorganic particle solely used in the state of dry powder, the spherical inorganic particle used in the state of dry powder plus the nano inorganic particle, or the spherical inorganic particle used in the state of dry powder plus the flaky inorganic particle may not achieve the tight packing effect due to their larger maximum allowable particle size.

In addition, it may be seen from Table 1 that if the single-size spherical inorganic particle dispersed in the dispersion liquid were solely used, the advantage of the high packing density still may not be obtained although the maximum allowable particle size is smaller. Only when the spherical inorganic particle with the larger particle size dispersed in the dispersion liquid is combined with the flaky inorganic particle and/or nano inorganic particle dispersed in the dispersion liquid may the effect of significantly reducing the CTE be obtained.

Table 2 provides a comparison of the properties of the composite material substrates of some examples and comparative examples of Table 1.

TABLE 2

| | | | glass transition | plane | | |
|---|---|---|---|---|---|---|
| peel | dielectric loss | dielectric constant | temperature (° C.) | direction | solder resistance | |
| strength | Df at 10 GHz | Dk at 10 GHz | measured by dynamic | CTE | heat resistance test | |
| (Lb/in) | frequency | frequency | mechanical analyzer | (ppm/° C.) | at 288° C. | |
| 6.9 | 0.008 | 3.9 | 325 | 1.2 | board uncracked in | Example 1 |
| | | | | | 10 minutes | |
| 7.5 | 0.008 | 3.88 | 330 | 1.5 | board uncracked in | Example 2 |
| | | | | | 10 minutes | |
| 7.2 | 0.0083 | 3.9 | 320 | 1.6 | board uncracked in | Example 3 |
| | | | | | 10 minutes | |
| 6 | 0.009 | 3.7 | 298 | 5 | board uncracked in | Comparative |
| | | | | | 10 minutes | Example 1 |
| 5 | 0.0099 | 4 | 300 | 6 | board uncracked in | Comparative |
| | | | | | 10 minutes | Example 2 |
| 6 | 0.009 | 4 | 320 | 5 | board uncracked in | Comparative |
| | | | | | 10 minutes | Example 3 |
| 5.3 | 0.0095 | | 310 | 4.1 | board uncracked in | Comparative |
| | | | | | 10 minutes | Example 4 |

From the contents of Table 1 and Table 2, it may be known that by dispersing the inorganic filler in the dispersion liquid, the CTE of the composite material substrate in the plane direction may be reduced. In addition, it may be seen from Table 2 that while reducing the CTE, Examples 1 to 3 of the disclosure still have excellent dielectric loss, dielectric constant, and peel strength, and an excellent performance when tested in the solder resistance heat resistance test at 288° C.

What is claimed is:

1. A composite material substrate, comprising:
an inorganic filler, wherein the inorganic filler comprises a first spherical inorganic particle and a filler material, an average particle diameter of the first spherical inorganic particle is 300 nm to 600 nm, the filler material comprises at least one of a second spherical inorganic particle and a flaky inorganic particle, an average particle diameter of the second spherical inorganic particle is 20 nm to 50 nm, and an average thickness of the flaky inorganic particle is 0.5 um to 2 um;
a resin composition, comprising a bismaleimide resin, a naphthalene ring-containing epoxy resin, and a benzoxazine resin; and
a dispersant, wherein the inorganic filler, the resin composition, and the dispersant are mixed together.

2. The composite material substrate according to claim 1, wherein in the resin composition, the bismaleimide resin is 10 wt % to 70 wt %, the naphthalene ring-containing epoxy resin is 10 wt % to 50 wt %, and the benzoxazine resin is 10 wt % to 50 wt %.

3. The composite material substrate according to claim 1, further comprising:
a hardener, wherein a weight of the hardener is greater than 0 parts by weight and less than or equal to 30 parts by weight, compared to a total of 100 parts by weight of the resin composition;
a siloxane coupling agent, wherein a weight of the siloxane coupling agent is 0.1 parts by weight to 4 parts by weight, compared to a total of 100 parts by weight of the resin composition; and
a catalyst, wherein a weight of the catalyst is greater than 0 parts by weight and less than or equal to 10 parts by weight, compared to a total of 100 parts by weight of the resin composition, and the inorganic filler, the resin composition, the dispersant, the hardener, the siloxane coupling agent, and the catalyst are mixed together.

4. The composite material substrate according to claim 1, wherein the filler material comprises the flaky inorganic particle, and a ratio of an average diameter to the average thickness of the flaky inorganic particle is greater than or equal to 10.

5. The composite material substrate according to claim 1, wherein the filler material comprises the second spherical inorganic particle, a ratio of the average particle diameter of the first spherical inorganic particle to the average particle diameter of the second spherical inorganic particle is 3 to 20.

6. The composite material substrate according to claim 1, wherein a weight of the inorganic filler is 100 parts by weight to 300 parts by weight, compared to a total of 100 parts by weight of the resin composition.

7. The composite material substrate according to claim 1, wherein a maximum allowable particle size of the first spherical inorganic particle is less than or equal to 5 um, a difference between a D10 and a D90 of the first spherical inorganic particle is less than 500 nm, and a difference between a D10 and a D90 of the second spherical inorganic particle is less than 20 nm.

8. A fabrication method of a composite material substrate, comprising:
mixing an inorganic filler, a dispersant, and a solvent to form a dispersion liquid; and
dissolving a resin composition into the dispersion liquid to form a varnish, wherein the resin composition comprises a bismaleimide resin, a naphthalene ring-containing epoxy resin, and a benzoxazine resin.

9. The fabrication method according to claim 8, further comprising:
impregnating the varnish with a glass fiber cloth; and
drying the varnish and the glass fiber cloth to form a film.

10. The fabrication method according to claim 8, further comprising:
sandwiching a film between two copper foils to obtain a copper foil substrate.
